(19) United States
(12) Patent Application Publication
(10) Pub. No.: US 2009/0099022 A1
(43) Pub. Date: Apr. 16, 2009

(54) NATURAL HERBICIDE CONTAINING LEMONGRASS ESSENTIAL OIL

(75) Inventors: Lorena Fernandez, Davis, CA (US); Brian Campbell, Davis, CA (US); Huazhang Huang, Davis, CA (US); Marja Koivunen, Davis, CA (US); Pamela G. Marrone, Davis, CA (US)

Correspondence Address: CHERYL H AGRIS PHD, PO BOX 806, PELHAM, NY, 10803, US

(73) Assignee: MARRONE ORGANIC INNOVATIONS, INC., Davis, CA (US)

(21) Appl. No.: 12/249,312

(22) Filed: Oct. 10, 2008

Related U.S. Application Data
(60) Provisional application No. 60/979,321, filed on Oct. 11, 2007.

(51) Int. Cl. A01N 37/02; A01N 65/44

(52) U.S. Cl. 504/142; 504/116.1

(57) ABSTRACT

The present invention discloses that a plant essential oil, lemongrass oil, is an effective pre and post emergence herbicide on both broadleaved and grass weeds. The lemongrass oil may be combined with corn oil and/or other oil and/or an organic acid, surfactants and other formulation ingredients to control the germination and growth of weeds. As a natural, non-toxic compound, it can be used as a safe alternative for weed control in organic farming systems.

### PRIORITY CLAIM

This application claims priority to application Ser. No. 60/979,321, filed Oct. 11, 2007, the contents of which are incorporated herein by reference.

### FIELD OF THE INVENTION

This invention relates to compositions and methods for controlling the germination and growth of broadleaf and grass weeds using compounds comprising lemongrass oil as an active ingredient.

### BACKGROUND OF THE INVENTION

Organic growers have discovered that corn gluten meal, a by-product in the manufacture of cornstarch, can serve as an effective pre-emergence herbicide. Corn gluten meal is commercially available as Bioweed™ (Chase, C. A., J. M. Scholberg, et al. (2004). “Preliminary evaluation of nonsynthetic herbicides for weed management in organic orange production.” Proc. Fla. State Hort. Soc. 117: 135-13). Since corn gluten meal affects only sprouting seeds, it is safe to use around mature or established plants. Herbicidal “soaps” and plant extracts serve as organic post-emergence herbicides. These products contain compounds with low toxicity, and they are generally degraded fast in the environment. Commercially available post-emergence herbicides include fatty acid (pelargonic acid) sold under the trade name Scythe™, essential oil (clove) sold as Matran™, and monoterpene (d-limonene) from citrus oil sold as Nature's Avenger™ and GreenMatch™.

Lemongrass oil is extracted from Lemongrass, Cymbopogon citratus (also known as Andropogon citratus, A. schoenathus—West Indian, Madagascar or Guatemala lemongrass; Andropogon flexuosus, Cymbopogon flexuosus—East Indian, Cochin, British India or native lemongrass), of the Poaceae family. The main chemical components of lemongrass oil are the two isomers of citral—geranial and neral-, myrcene, linalool, and geranyl acetate (Carlson, L. H. C., R. A. F. Machado, et al. (2001). “Extraction of lemongrass essential oil with dense carbon dioxide.” Journal of Supercritical Fluids 21: 33-39).

Lemongrass oil has been demonstrated to have antimicrobial, antiseptic, bactericidal, fungicidal (Chao, S. C., D. G. Young, et al. (2000). “Screening for inhibitory activity of essential oils on selected bacteria, fungi and viruses.” Journal of Essential Oil Research 12: 639-649) as well as insecticidal (Ngoh, S. P., L. E. W. Choo, et al. (1998). “Insecticidal and repellent properties of nine volatile constituents of essential oils against the American cockroach, Periplaneta americana (L.)” Pesticide Science 54: 261-268 and Zhu, B. C. R., G. Henderson, et al. (2001). “Evaluation of vetiver oil and seven insect-active essential oils against the formosan subterranean termite.” Journal of Chemical Ecology 27: 1617-1625.) properties.

### SUMMARY OF THE INVENTION

The present invention discloses the use of lemongrass oil as a pre- and post-emergence herbicide against weeds. It can serve as a safer alternative to synthetic herbicides now on the market. A primary object of the invention is to provide novel herbicidal compositions against both broadleaf and grass weeds that contain lemongrass oil as an active ingredient. Another object is to provide a safe, food-grade, non-toxic herbicidal composition and a method that will not harm the environment. The above and other objects are accomplished by the present invention which is directed to herbicidal compositions containing lemongrass oil with other plant essential oils and stabilizers or carriers to control the germination and growth of weeds.

In particular, the invention is directed to a phytotoxic or herbicidal composition comprising (a) lemongrass essential oil; (b) at least one of (i) one or more carrier oil (ii) one or more non lemongrass essential oil or (iii) one or more organic acid and (c) optionally at least one of (i) one or more surfactant; (ii) one or more emulsifier; (iii) one or more antifreezer and/or (iv) one or more stabilizer. This composition may be used in modulating monocotyledonous and/or dicotyledenous weeds.

In another particular embodiment, the essential oils in the composition are mixed with an organic acid such as formic acid, acetic acid, propionic acid, citric acid, malonic acid, or malic acid. In a particular embodiment, lemongrass oil is mixed with citrus oil (d-limonene), cinnamon bark oil and/or corn oil for enhanced efficacy.

The composition may further comprise a second herbicidal agent. These include but are not limited to chemical herbicides such as paraquat and glyphosate.

In a particular embodiment, the composition of the present invention is essentially free of herbicidally effective amounts of wintergreen oil, clove oil, citronella oil, butyl laurate and/or isopropyl containing compounds such as isopropyl myristate, isopropyl palmitate, isopropyl acetate, isopropyl lanolin, isopropyl stearate, isopropylamine, isopropylamine salt of oleoylisopropanolamide, isopropylamine sulfate, 4-isopropylidene-1-methylcylohexene, 4,4′-isopropylidenediphenol C₁₂₋₁₅-alkyl phosphate, isopropylnapthalenesulfonic acid sodium salt, and isopropylsulfamic acid.

In yet another embodiment, the invention is directed to a method for modulating growth of monocotyledonous or dicotyledonous weeds comprising applying to said weeds an amount of lemongrass oil or composition of the present invention effective to modulate growth of said weeds. In a particular embodiment, lemongrass oil is applied in an amount ranging from about 1% to about 10% and in a specific embodiment, about 1% to 5%. In a particular embodiment, the lemongrass oil is applied to the leaves, stems, flowers, foliage and/or roots of said weeds.

In yet a more particular embodiment, the lemongrass oil used in the method of the present invention is formulated into the composition of the present invention. In particular, the invention is directed to the use of lemongrass essential oil or composition of the present invention for the formulation of a post-emergence herbicide, particularly to control both broadleaved and grass weeds. Lemongrass essential oil in the instant invention may be used as a pre- or post-emergence herbicide when applied together with at least one of: (a) one or more non-lemongrass essential oil; (b) one or more organic acid; (c) one or more chemical or bio herbicide; (d) one or more carrier oils.

### DETAILED DESCRIPTION OF THE INVENTION

While the compositions and methods heretofore are susceptible to various modifications and alternative forms, exemplary embodiments will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

Where a range of values is provided, it is understood that each intervening value, to the tenth of the unit of the lower limit unless the context clearly dictates otherwise, between the upper and lower limit of that range and any other stated or intervening value in that stated range, is included therein. Smaller ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

Lemongrass oil utilized in this invention may be extracted from conventional sources, for example from Lemongrass, Cymbopogon citratus (also known as Andropogon citratus, A. schoenathus—West Indian, Madagascar or Guatemala lemongrass or from Cymbopogon flexuosus (also known as Andropogon flexuosus—East Indian, Cochin, British India or native lemongrass) (natural products), or can be purchased from commercial sources.

In one embodiment, the present invention provides a herbicidal composition comprising, in admixture with a suitable carrier and optionally with a suitable emulsifying agent, lemongrass oil. In a particular embodiment, the active ingredient, lemongrass oil, is present in the composition of the present invention in the amount of about 5% weight to about 70% by weight. For use, this product will be diluted 5 to 15-fold to give a final concentration of lemongrass of about 0.3-15%. In yet another particular embodiment, the lemongrass may be present in the composition up to about 60% in the presence of another plant essential oil such as citrus oil (or d-limonene), cinnamon oil, a carrier and an emulsifier. In a specific embodiment, the composition of the present invention comprises lemongrass oil, a stabilizer, an antifreezer, a carrier and surfactants.

In a more specific embodiment, the composition comprises:

Lemongrass oil: 5-70%

Another herbicide 0-50%

Surfactants: 5-35%

Stabilizer: 0-8%

Antifreezer: 0-6%

Water: 10-70%

Carrier: 0-35%

In one embodiment, surfactants may be glycerol esters; in another embodiment, surfactant 1 is a blocked copolymer and surfactant 2 is lecithin; in yet another embodiment, surfactant 1 is a lecithin and surfactant 2 is a glycerol ester; in yet another embodiment, surfactant 1 is an ethoxylated alcohol and surfactant 2 is a lecithin.

In another particular embodiment, the composition comprises lemongrass essential oil, at least one (one or more) carrier oil, at least two (two or more) emulsifiers and optionally at least one (one or more) surfactant. Even more particularly, said composition comprises between about 40-90% lemongrass essential oil, between about 5%-20% carrier oil, between about 4.0-20% of a first emulsifier, between about 1.0-20% of a second emulsifier and between about 0.0-20.0% surfactant. Examples of such formulations include but are not limited to: (A) 56% Lemongrass Essential Oil; 24% Corn Oil; 5% Glycerol Esters; 5% Polyglyceryl-2 Stearate and 10% Glycerol mono/dioleate.

In yet another particular embodiment, the composition comprises lemongrass essential oil, at least one (one or more) carrier oil, at least two (two or more) emulsifiers and at least one (one or more) surfactant. In a particular embodiment, one emulsifier is lecithin and the other emulsifier is sodium lauryl sulfate. The surfactant may be an anionic surfactant or a nonionic surfactant. Even more particularly, said composition comprises between about 30.0-88.0% lemongrass essential oil, between about 2.5-40.0% carrier oil, between about 2.5-40% carrier oil, between about 0.1-3.0% of each surfactant and between about 3.3-20.0% emulsifier. Examples of such compositions include but are not limited to: (A) 1.8% of Sodium Lauryl Sulfate; 1% of Lecithin; 30.2% of Deionizer water; 57% of Lemongrass Essential Oil; 3% of Corn Oil and 7% of Glycerol Esters.

In an even another particular embodiment, said composition comprises lemongrass essential oil, one or more carrier oil, one or more organic acid. The organic acid may be formic, acetic, propionic, citric, oxalic, malic or malonic acid. Even more particularly, said composition comprises lemongrass essential oil, one or more carrier oil, one or more organic acid, one or more surfactant and one or more emulsifier. The composition may comprise about 30-70% Lemongrass Essential Oil, about 15-20% Carrier Oil, about 10-25% Organic Acid, about 2.5-10% Surfactant and about 2.5-10% Emulsifier. Examples of such compositions include but are not limited to: (A) 50% Lemongrass Essential Oil, 20% Corn Oil, 17.5% Acetic acid, 10% Glycerol Esters and 2.5% Sodium Lauryl Ester.

In yet even another particular embodiment, said composition comprises lemongrass essential oil, a second essential oil and optionally further comprises one or more surfactants, one or more stabilizers and one or more antifreezer. The composition may in particular comprise about 5-30% lemongrass essential oil, about 5-30% of a non-lemongrass essential oil, about 10-30% surfactant, about 1-6% antifreezer, about 1-8% stabilizer. Examples of such compositions include but are not limited to 10% lemongrass essential oil, 10% d-limonene, 11% sodium laurel sulfate, 5% undeceth, 2% sodium/ammonium/potassium bicarbonate, 4% propylene glycol, 58% water. Another example includes 15% lemongrass essential oil, 7.5% d-limonene, 7.5% sodium lauryl sulfate, 5% undeceth 79, 2% sodium/ammonium/potassium bicarbonate, 4% propylene glycol, 59% water. Another example includes 10% lemongrass oil, 10% urea, 6% undeceth, 9% sodium lauryl sulfate, 3% propylene glycol and 65% water. In a preferred embodiment, the pH is about 7-9.

The compositions of the invention may comprise a carrier and/or diluent. The term, “carrier” as used herein means an inert, organic or inorganic material, with which the active ingredient is mixed or formulated to facilitate its application to the soil, seed, plant or other object to be treated, or its storage, transport and/or handling. The carrier used will depend on whether it is being used in a pre- or post-emergence herbicide. Liquid carriers can be used for both pre and post-emergence applications. In a particular embodiment, carrier oils may be used. Examples of such carrier oils include but are not limited to corn oil, linseed oil. Other non-polar oils are also suitable carriers, for example vegetable oils and seed oil as well as mineral oils and petroleum distillates. Carrier vehicles for the pre-emergence herbicide include, but are not limited to, active charcoal, corn gluten meal, soybean meal, vermiculite, bentonite, kaolinite, wheat germ, almond hulls, cottonseed meal, Fuller's earth, orange pulp, rice hulls, sawdust, Gum arabic, etc. If desired, plant essential oils such as cinnamon, citrus oil (d-limonene) thyme (eugenol as active ingredient), citronella and pine oil, and the like, can be included in the granules to improve the pre-emergence and post-emergence effect of lemongrass. Examples of diluents or carriers for the post-emergence herbicides include, but are not limited to, water, milk, ethanol, mineral oil, vegetable oil, glycerol, and organic acids such as formic acid, acetic acid, propionic acid, citric acid etc.

The composition may additionally comprise a surfactant to be used for the purpose of emulsification, dispersion, wetting, spreading, integration, disintegration control, stabilization of active ingredients, and improvement of fluidity or rust inhibition. The choice of dispersing and emulsifying agents, such as non-ionic, anionic, amphoteric and cationic dispersing and emulsifying agents, and the amount employed is determined by the nature of the composition and the ability of the agent to facilitate the dispersion of the herbicidal compositions of the present invention. Examples of surfactants used in the compositions of the present invention include but are not limited to ethoxylated alcohols, ethoxylated fatty esters, ethoxylated castor oil, alkoxylated glycols, ethoxylated fatty acids, carboxylated alcohols, carboxylic acids, fatty acids, ethoxlylated alkylphenols, fatty esters, lignins, blocked copolymers, EO/PO copolymers, sodium lauryl sulfate, Octadecanoic acid, ammonium salt, 9-Octadecenoic acid (9Z)-, potassium salt. In particular, emulsifiers that may be used include but are not limited to caprol, PGE, sodium lauryl sulphate, lecithin, or salts of oleic acid.

The composition may further comprise one or more stabilizers. Examples of stabilizers include but are not limited to a pH adjusting agent to make the composition a weaker base, neutral or a weak acid (pH 5-9, preferably pH 6-8) such as citric acid, malic acid, sodium bicarbonate, potassium bicarbonate and so on.

The compositions of the present invention may further comprise antifreezers. Antifreezers are defined as that compounds are added to water to reduce the freezing point of the mixture to below the lowest temperature that the system is likely to be exposed to. Examples of antifreezers include but are not limited to urea, diols (e.g., ethylene glycol, propylene glycol) and organic acids (e.g., lactic acid, DEX-COOL).

The compositions of the present invention may be sprayed on the plant or applied to the soil. Particular embodiments are described in the Examples, infra. These compositions may be in the form of water degradable granules, wettable powder, emulsifiable concentrate, emulsifiable acidified concentrate, liquid preparation, suspension concentrate, or oil suspension, microemsulsion, soluble liquid, micro-encapsulation.

For pre-emergence dry formulations, the granule size of the carrier is typically 1-2 mm (diameter) but the granules can be either smaller or larger depending on the required ground coverage. Granules may comprise of porous or non-porous particles.

For post-emergent formulations, the formulation components used may contain smectite clays, attapulgite clays and similar swelling clays, thickeners such as xanthan gums, gum Arabic and other polysaccharide thickeners as well as dispersion stabilizers such as nonionic surfactants (for example polyoxyethylene (20) monolaurate). The concentration of the clays may vary between 0-2.5% w/w of the total formulation, the polysaccharide thickeners may range between 0-0.5% w/w of the total formulation and the surfactants may range between 0-5% w/w of the total formulation.

The composition and method of the present invention will be further illustrated in the following, non-limiting Examples. The examples are illustrative of various embodiments only and do not limit the claimed invention regarding the materials, conditions, weight ratios, process parameters and the like recited herein.

### EXAMPLES

The composition and method of the present invention will be further illustrated in the following, non-limiting Examples. The examples are illustrative of various embodiments only and do not limit the claimed invention regarding the materials, conditions, weight ratios, process parameters and the like recited herein.

### Example 1

Numerous natural compounds were screened for their ability to inhibit the germination of dicot (broadleaved weed) seeds. A single seed of Lactuca sativa (lettuce) was placed in each well of a 96-well plate followed by 50 uL of a solution of each compound in a stepwise (5×) dilution series from 50% to 0%. Germination was monitored daily. Based on this screening study, the threshold value for lemongrass oil to inhibit germination of seeds was determined at 0.016%.

### Example 2

A high-throughput 96-well assay was used to test the efficacy of lemongrass oil as a post-emergence, non-selective herbicide. Seedlings of Lactuca sativa (lettuce) were grown in 96-well plates under continuous light. Lemongrass oil was added on the one-week old seedlings at a 5×-dilution series from 50 to 0%, and the minimum concentration needed for killing the seedling was recorded the next day. According to the results, lemongrass oil at a concentration of 0.125% was able to kill the lettuce seedlings where as lemongrass oil at a concentration 0.025% was not harmful to the plant.

### Example 3

A 96-well plate assay was conducted to investigate the pre-and post emergence effect of different combinations of lemongrass, cinnamon bark oil (Cinnamon zeylanicum) and corn oil on lettuce (Lactuca sativa) seeds and seedlings. Each test was conducted in two replicates as described above. The starting solution in each 5× dilution series contained 100% oil. The minimum inhibitory concentrations (MIC %) for each test compounds are presented in Table I.

TABLE I

| | | | | pre- | post- |
|---|---|---|---|---|---|
| Test | lemongrass | cinnamon | | emergence | emergence |
| compound | oil % | oil % | corn oil % | MIC (%) | MIC (%) |
| 1 | 0 | 100 | 0 | 0.064 | 1.16 |
| 2 | 16.65 | 16.65 | 66.7 | 0.064 | 0.869 |
| 3 | 50 | 50 | 0 | 0.043 | 1.24 |
| 4 | 50 | 0 | 50 | 0.00128 | 1.33 |
| 5 | 0 | 0 | 100 | 0.32 | 4.49 |
| 6 | 33.3 | 33.3 | 33.3 | 0.00256 | 1.067 |
| 7 | 16.65 | 66.7 | 16.65 | 0.00256 | 0.83 |
| 8 | 100 | 0 | 0 | 0.00256 | 1.16 |
| 9 | 0 | 50 | 50 | 0.000051 | 0.869 |
| 10 | 66.7 | 16.65 | 16.65 | 0.00256 | 1.333 |

According to the results, all the tested combinations containing lemongrass and/or cinnamon bark oil or both worked very well as a pre-emergence herbicide; 50/50 combination of cinnamon and corn oil gives the best pre-emergence effect (inhibition at 0.000051%). Addition of corn oil in the test solution (50%) improves the pre-emergence effect of lemongrass oil and lowers the MIC from 0.00256% to 0.00128%. For post-emergence effect, a higher concentration of active ingredients (around 1%) is required than for the pre-emergence effect. A combination of ⅕ lemongrass oil, ⅕ corn oil and ⅗ of cinnamon oil was the most effective combination with a MIC of 0.83%.

### Example 4

In another 96-well plate assay, the synergy between lemongrass, corn oil, and the Caprol PGE 860 (deca glycerol mono-dioleate) surfactant as well as lemongrass, cinnamon, and corn oil were tested on Lactuca sativa seedlings. The starting concentration in the 1:1 dilution series was 60.9% for the lemongrass/corn oil formulation and 51.7% for the lemongrass/cinnamon/corn oil formulation. The minimum inhibitory concentration (MIC %) required for a complete kill of the seedling for each formulation is presented in Tables II and III below.

TABLE II

| Mixture of | Caprol PGE860 | | Minimum | |
|---|---|---|---|---|
| lemongrass | (deca glycerol | | inhibitory | |
| (70%) and corn | mono-dioleate) | Number of | concentration | Standard |
| oil (30%) % | % | replicates | % | deviation |
| 90 | 10 | 8 | 7.62 | 1.97 |
| 82.5 | 17.5 | 2 | 7.61 | 0 |
| 85 | 15 | 6 | 3.92 | 2.12 |
| 80 | 20 | 8 | 6.66 | 5.26 |
| 87.5 | 12.5 | 2 | 7.6 | 1.56 |

TABLE III

| Mixture of | Caprol PGE | | | |
|---|---|---|---|---|
| lemongrass | 860 | | | |
| (59.5%), corn oil | (deca | | Minimum | |
| (25.5%) and | glycerol- | | inhibitory | |
| cinnamon bark | mono- | Number of | concentration | Standard |
| oil (15%) % | dioleate) % | replicates | % | deviation |
| 90 | 10 | 8 | 6.73 | 2.82 |
| 82.5 | 17.5 | 2 | 5.41 | 0 |
| 85 | 15 | 6 | 5.57 | 2.16 |
| 80 | 20 | 8 | 4.39 | 2.06 |
| 87.5 | 12.5 | 2 | 3.89 | 0.75 |

A pot study was conducted to test the phytotoxicity of 2 herbicidal formulations on both broadleaved and grass weeds. The formulations tested were:

1. lemongrass oil (59.5%), corn oil (25.5%) cinnamon cassia oil (15%), Caprol PGE (15%)

2. lemongrass oil (70%), corn oil (30%), caprol PGE 860 (15%)

Ten seeds of either chickweed (Stellaria media) or annual bluegrass (Poa annua) were planted in a peat pot filled with potting mix. The 2-inch tall plants grown under growth lights (12-h light/12-h dark) at room temperature were sprayed with the above-mentioned formulations containing 1.0, 2.0, 3.0, and 5.0% active ingredients. A solution of DI water (0% A.I.) was used as a control treatment. The plants were kept at room temperature under growth lights and observed three days after the treatment for % weed control (see Table IV below).

TABLE IV

| Formulation # and | Stellaria media | Poa annua |
|---|---|---|
| concentration(%) | (% control) | (% control) |
| 0 | 0 | 0 |
| #1 - 1.0% | 2% | 4% |
| #1 - 2.0% | 35% | 45% |
| #1 - 3.0% | 43% | 55% |
| #1 - 5.0% | 92.5% | 100% |
| #2 - 1.0% | 1% | 3.5% |
| #2 - 2.0% | 40% | 45% |
| #2 - 3.0% | 50% | 65% |
| #2 - 5.0% | 100% | 95% |

At 5% (A.I.), both formulations resulted in a practically complete control both a representative broadleaf weed (chickweed; Stellaria media) and a grass weed (Annual bluegrass, Poa annua). At the A.I. concentration of 3%, only about 50% of weeds were controlled. Both formulations seem to be equal in terms of herbicidal effect.

### Example 5

In a field study the efficacy of an emulsifiable concentrate containing lemongrass essential oil, water, corn oil, glycerol esters, potassium oleate and lecithin was tested on the most common winter weeds in California (redstem filaree, little mallow, Shepherd's purse, London rocket, hairy fleabane, and annual bluegrass). Table V below describes the weed control efficacy of the formulation.

TABLE V
WEED CONTROL EFFICACY (%) 20 DAYS AFTER TREATMENT
(gpa—gallons per acre)

| | Gallons | | | | | | |
|---|---|---|---|---|---|---|---|
| | per | | | | | | |
| | acre | Redstem | Little | Shepherd's | London | Hairy | Annual |
| Treatment | (gpa) | filaree % | mallow % | purse % | rocket % | fleabane % | bluegrass % |
| Untreated | | 0 | 0 | 0 | 0 | 0 | 0 |
| 7.5% | 35 | 6.25 | 7.5 | 12.5 | 11.25 | 8.75 | 6.5 |
| 10% | 35 | 10 | 11.25 | 35 | 33.75 | 33.75 | 7.5 |
| 15% | 35 | 42.5 | 37.5 | 50 | 52.5 | 52.5 | 17.5 |
| 7.5% | 70 | 30 | 30 | 63.75 | 58.75 | 61.25 | 13.75 |
| 10% | 70 | 68.75 | 77.25 | 92 | 92.5 | 93.75 | 52.5 |
| 15% | 70 | 76.25 | 72.5 | 94.75 | 94.75 | 98 | 63.75 |
| 7.5% | 100 | 68.75 | 75 | 94.75 | 94.75 | 94.75 | 80 |
| 10% | 100 | 77.5 | 92 | 99.5 | 99.5 | 99 | 80 |
| 15% | 100 | 94.5 | 87.5 | 100 | 100 | 100 | 92.5 |
| Greenmatch ™ | 60 | 66.25 | 71.25 | 94.25 | 94.25 | 96 | 62.5 |
| 18% | | | | | | | |
| Matran ® 5% | 60 | 40 | 42.5 | 48.75 | 46.25 | 40 | 21.25 |

The results in Table V above show control (%) of some broadleaf and grass weeds using various concentrations (%) and volumes (gpa) of test product. GreenMatch™, a product of Marrone Organic Innovations contains d-limonene as an active ingredient; Matran® is a product of EcoSmart and contains clove oil as an active ingredient.

Although this invention has been described with reference to specific embodiments, the details thereof are not to be construed as limiting, as it is obvious that one can use various equivalents, changes and modifications and still are within the scope of the present invention.

Various references are cited throughout this specification, each of which is incorporated herein by reference in its entirety.

What is claimed is:

1. An herbicidal composition comprising (a) lemongrass essential oil; (b) at least one of (a) one or more carrier oil (b) one or more non lemongrass essential oil or (c) one or more organic acid and (c) optionally at least one of (i) one or more surfactant; (ii) one or more emulsifier; (iii) one or more antifreezer and (iv) one or more stabilizer.

2. The herbicidal composition according to claim 1, wherein said lemongrass essential oil is present in an herbicidally effective amount.

3. The herbicidal composition according to claim 1, wherein said carrier oil is selected from the group consisting of corn oil and linseed oil.

4. The herbicidal composition according to claim 1 wherein said composition comprises lemongrass essential oil and one or more carrier oil.

5. The herbicidal composition according to claim 4, wherein said composition comprises lemongrass essential oil and corn oil.

6. The herbicidal composition according to claim 1, wherein said surfactant is an anionic surfactant or nonionic surfactant.

7. The herbicidal composition according to claim 1, wherein the surfactant is selected from the group consisting of ethoxylated alcohols, ethoxylated alcohols, ethoxylated fatty esters, ethoxylated castor oil, alkoxylated glycols, ethoxylated fatty acids, carboxylated alcohols, carboxylic acids, fatty acids, ethoxlylated alkylphenols, fatty esters, lignins, blocked copolymers, EO/PO copolymers, Octadecanoic acid, ammonium salt, 9-Octadecenoic acid (9Z)-, potassium salt.

8. The herbicidal composition according to claim 1, wherein said composition comprises lemongrass essential oil, one or more carrier oil, one or more emulsifier and optionally at one or more surfactant.

9. The herbicidal composition according to claim 8, wherein said composition comprises lemongrass essential oil, one or more carrier oil, two or more emulsifiers and optionally at least one or more surfactant.

10. The herbicidal composition according to claim 9, wherein said composition comprises between about 40-90% of said lemongrass essential oil, between about 5%-20% of said carrier oil, between about 4.0-20% of one of said emulsifiers, between about 1.0-20% of another said emulsifier and between about 0.0-20.0% of said surfactant.

11. The herbicidal composition according to claim 8, wherein said composition comprises lemongrass essential oil, one or more carrier oil, two or more emulsifier and one or more surfactants.

12. The herbicidal composition according to claim 11, wherein one emulsifier is lecithin.

13. The herbicidal composition according to claim 11, wherein said composition comprises between about 30.0-88.0% of said lemongrass essential oil, between about 2.5-40.0% of said carrier oil, between about 0.1-3.0% of each surfactant and between about 3.3-20.0% of said emulsifier.

14. The herbicidal composition according to claim 1, wherein said composition comprises lemongrass essential oil, one or more carrier oil and one or more organic acid.

15. The herbicidal composition as according to claim 1, wherein said organic acid is formic, acetic, propionic, citric, oxalic, malic or malonic acid.

16. The herbicidal composition according to claim 1, wherein said emulsifier is caprol, PGE, sodium lauryl sulphate, lecithin, or salts of oleic acid.

17. The herbicidal composition according to claim 1, wherein said antifreezer is selected from the group consisting of urea, diols and an organic acid.

18. The herbicidal composition according to claims 1, wherein said antifreezer is a diol and said diol is ethylene glycol or propylene glycol.

19. The herbicidal composition according to claim 1, wherein said antifreezer is an organic acid and said organic acid is lactic acid.

20. The herbicidal composition according to claim 1, wherein said stabilizing agent is citric acid, malic acid, ammonium bicarbonate, sodium bicarbonate or potassium bicarbonate.

21. The herbicidal composition according to claim 1, wherein said composition comprises lemongrass essential oil, one or more non lemongrass essential oil and optionally further comprises one or more surfactant, one or more stabilizer or one or more antifreezers.

22. The composition according to claim 21, wherein said composition comprises about 5-30% of said lemongrass essential oil, about 5-30% of said non lemongrass essential oil, about 10-30% surfactant, about 1-6% antifreeze, about 1-8% stabilizer.

23. The composition according to claim 1, wherein said non-lemongrass essential oil is d-limonene.

24. The composition according to claim 1, wherein said composition comprises a second herbicidal agent.

25. The herbicidal composition of claim 1, wherein said composition is an emulsion.

26. A method for modulating growth of monocotyledonous or dicotyledonous weeds comprising applying to said weeds an amount of lemongrass essential oil effective to modulate growth of said weeds.

27. A method for modulating emergence of monocotyledonous or dicotyledonous weeds in soil comprising applying to said weeds or soil an amount of the composition of claim 1 effective to modulate emergence of said weeds.

28. The herbicidal composition of claim 1, wherein said composition is essentially free of herbicidally effective amounts of wintergreen oil, clove oil, citronella oil, butyl laurate isopropyl myristate, isopropyl palmitate, isopropyl acetate, isopropyl lanolin, isopropyl stearate, isopropylamine, isopropylamine salt of oleoylisopropanolamide, isopropylamine sulfate, 4-isopropylidene-1-methylcylohexene, 4,4′-isopropylidenediphenol C₁₂₋₁₅-alkyl phosphate, isopropylnapthalenesulfonic acid sodium salt, and/or isopropylsulfamic acid.
